(19) United States
(12) Patent Application Publication
(10) Pub. No.: US 2013/0011262 A1
(43) Pub. Date: Jan. 10, 2013

(54) Downwind Variable Pitch Wind Turbine Generator

(75) Inventors: Xuegen Xu, Jiaxing (CN); Kai Yu, Jiaxing (CN); Guorong He, Jiaxing (CN)

(73) Assignee: ZHEJIANG HUAYING WAIND POWER GENERATOR CO., LTD., Jiaxing, Zhejiang (CN)

(21) Appl. No.: 13/634,873

(22) PCT Filed: May 22, 2011
(86) PCT No.: PCT/CN2011/074483

§ 371 Date: Sep. 13, 2012

(30) Foreign Application Priority Data
Jun. 4, 2010 (CN) 201010191997.5

(51) Int. Cl. F03D 1/06

(52) U.S. Cl. 416/147

(57) ABSTRACT

The invention designs a downwind variable pitch wind turbine generator which mainly comprises a wheel hub, a main shaft, a generator, a frame and a base, wherein a synchronizing disc is arranged in the wheel hub, the synchronizing disc is connected with a fan blade connection slewing bearing through two joint bearings which are in mutual butt joint, one end of a reciprocating rod arranged in the main shaft is connected with the synchronizing disc, the other end of the reciprocating rod is connected with a displacement sleeve, an electric push rod is arranged in the frame, and the displacement sleeve is connected with the electric push rod. The downward variable pitch wind turbine generator is mainly suitable for medium and small-sized fans, and a pitch control mechanism of the downward variable pitch wind turbine generator can control three blades to change pitch simultaneously and keep the pitch-changing amplitude consistent; and the pitch control mechanism can enable each blade to change the pitch to a certain negative angle, realize the shutdown of the downward variable pitch wind turbine generator and keep the shutdown state under harsh conditions, such as hurricane and the like. The frame can rotate 360 degrees relative to the base so as to adapt to all wind directions. In addition, the downwind variable pitch wind turbine generator is further provided with an anemometer and a controller, so that the reaction is more sensitive and the downwind variable pitch wind turbine generator can be suitable for wind direction and wind speed, which change suddenly.

### FIELD OF THE INVENTION

The invention relates to the field of wind turbine generators, in particular to a downwind wind turbine generator suitable for medium and small-sized fans.

### BACKGROUND OF THE INVENTION

At present, large fans have basically used variable-pitch and variable-speed regulation and thus show the advantages of stable power output and more reliable operation of the fans. As for small fans, because blades are smaller, the blades can generate the smaller force under the action of wind, which can not enable centrifugal hammers to twist and can not achieve the variable control effect. Therefore, there are more wind turbine generators with stern rudder yawing in upwind of the small fans, not only is output unstable, but also the failure problems caused by poor speed-limiting effect of the fans under strong wind are more and the operation is unreliable.

### SUMMARY OF THE INVENTION

The invention aims at providing a downward variable pitch wind turbine generator with simple structure, high efficiency and reliability for solving the above technical insufficiencies.

In order to achieve the purpose, the invention designs a downwind variable pitch wind turbine generator which mainly comprises a wheel hub, a main shaft, a generator, a frame and a base, wherein a synchronizing disc is arranged in the wheel hub, the synchronizing disc is connected with a fan blade connection slewing bearing through two joint bearings which are in mutual butt joint, a reciprocating rod connected with a sliding pair is arranged in the main shaft, one end of the reciprocating rod is connected with the synchronizing disc, the other end of the reciprocating rod is connected with a displacement sleeve, an electric push rod is arranged in the frame, the displacement sleeve is connected with the electric push rod, and the electric push rod is electrically connected with a signal sliding ring mounted in the base. Therefore, the downwind variable pitch wind turbine generator can make responses rapidly and further realize the effects of pitch control and shutdown.

The wheel hub is connected with the main shaft through a connecting flange, the main shaft is connected with a main bearing seat and an auxiliary bearing seat through a self-aligning roller bearing and fixed on the frame through an elastic support block, and the main shaft is connected with the generator through an elastic shaft coupling. The structure is compact, and the operation is more smooth and reliable.

A slewing bearing is arranged between the frame and the base, and a power transmission sliding ring is arranged in the base. The frame can rotate 360 degrees relative to the base so as to adapt to all wind directions.

The downward variable pitch wind turbine generator obtained by the invention is mainly suitable for medium and small-sized fans, a main body is simple and compact in structure, safe and reliable, and the downward variable pitch wind turbine generator is provided with the elastic support block so that deflection and vibration caused by the rotation of a wind wheel can not be transferred onto the generator and the frame in a rigid manner and the operation is more smooth and reliable. A pitch control mechanism of the downward variable pitch wind turbine generator can control three blades to change pitch simultaneously and keep the pitch-changing amplitude consistent. The pitch control mechanism can enable each blade to change the pitch to a certain negative angle, realize the shutdown of the downward variable pitch wind turbine generator and keep the shutdown state under harsh conditions, such as hurricane and the like. The frame can rotate 360 degrees relative to the base so as to adapt to all wind directions. In addition, the downwind variable pitch wind turbine generator is further provided with an anemometer and a controller, so that the reaction is more sensitive, the downwind variable pitch wind turbine generator can be suitable for wind direction and wind speed, which change suddenly, the effects are better and a range of applicable regions is wider.

### BRIEF DESCRIPTION OF THE DRAWINGS

FIG. 1 is a sectional view of the invention;

FIG. 2 is a front view of the embodiment of the invention;

FIG. 3 is a lateral view of the embodiment of the invention.

1: wheel hub; 2: bearing seat of main shaft; 3: self-aligning roller bearing; 4: main shaft; 5: displacement sleeve; 6: auxiliary bearing seat; 7: elastic shaft coupling; 8: generator; 9: connecting flange; 10: frame; 11: slewing bearing; 12: base; 13: joint bearing; 14: reciprocating rod; 15: synchronizing disc; 16: elastic support block; 17: fan blade connection slewing bearing; 18: electric push rod; 19: power transmission sliding ring; 20: signal sliding ring.

### DETAILED DESCRIPTION OF THE INVENTION

In combination with the following embodiments and figures, the invention is further described.

### Embodiment 1

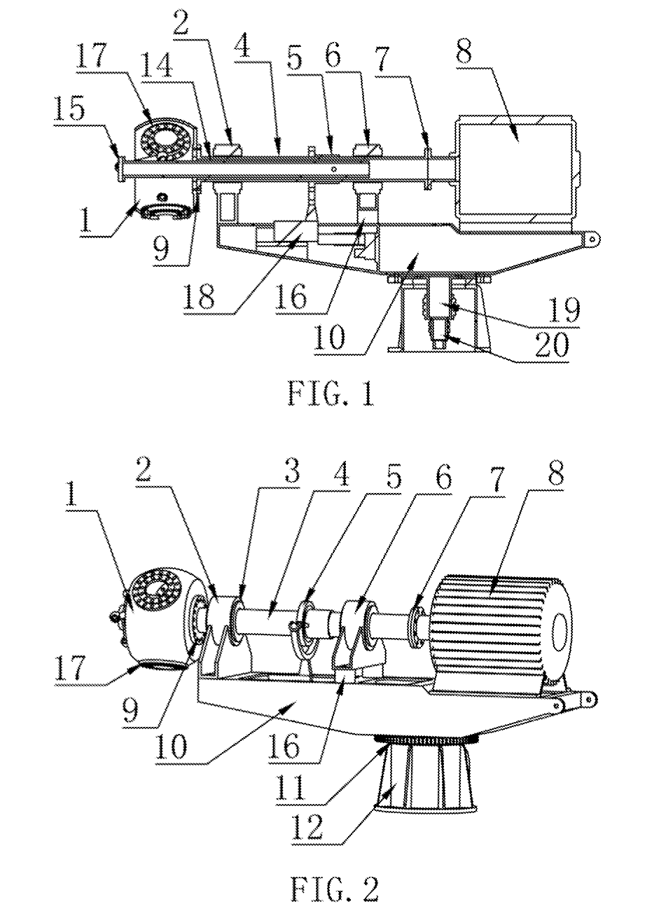

As shown in FIG. 1, a downwind variable pitch wind turbine generator described by the embodiment mainly comprises a wheel hub 1, a main shaft 4, a generator 8, a frame 10 and a base 12, wherein a synchronizing disc 15 is arranged in the wheel hub 1, the synchronizing disc 15 is connected with a fan blade connection slewing bearing 17 through two joint bearings 13 which are in mutual butt joint, a reciprocating rod 14 connected with a sliding pair is arranged in the main shaft 4, one end of the reciprocating rod 14 is connected with the synchronizing disc 15, the other end of the reciprocating rod 14 is connected with a displacement sleeve 5, an electric push rod 18 is arranged in the frame 10, the displacement sleeve 5 is connected with the electric push rod 18, and the electric push rod 18 is electrically connected with a signal sliding ring 20 mounted in the base 12.

When an anemometer monitors the situation that wind speed is too large, a controller can give out a command to command the electric push rod 18 to expand and contract, then the electric push rod 18 can draw the displacement sleeve 5 to move, the synchronizing disc 15 can be driven to move through the reciprocating rod 14, and the joint bearings 13 on the synchronizing disc 15 can further draw the fan blade connection slewing bearing 17 to rotate for realizing pitch control of fan blades. When hurricane or abnormal situation of a fan is detected and shutdown is required, the controller can give out a signal to start a pitch control mechanism to work for realizing the pitch control of the fan blades; and when the pitch is changed to a certain negative angle, wind can give a reverse force to the fan for stopping the fan and the force is further smaller than that required for starting the fan, so that the fan can be prevented from running in reverse direction and the fan can always in shutdown state.

### Embodiment 2

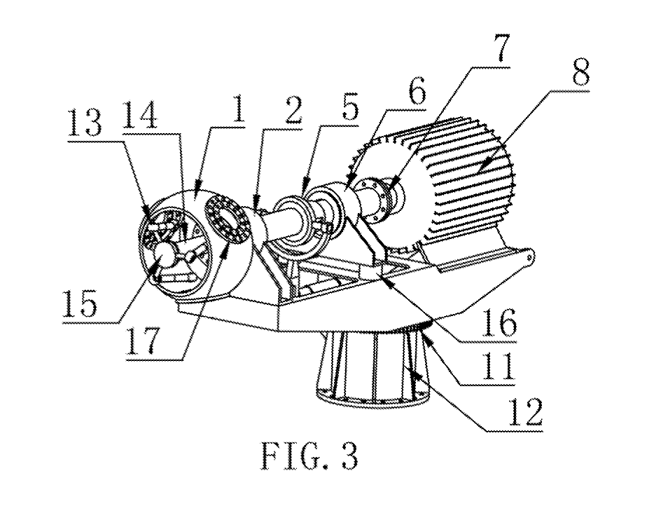

As shown in FIG. 2 and FIG. 3, in a downwind variable pitch wind turbine generator described by the embodiment, a wheel hub 1 is connected with a main shaft 4 through a connecting flange 9, the main shaft 4 is connected with a main bearing seat 2 and an auxiliary bearing seat 6 through a self-aligning roller bearing 3 and fixed on a frame 10 through an elastic support block 16, the main shaft 4 is connected with a generator 8 through an elastic shaft coupling 7, a slewing bearing 11 is arranged between the frame 10 and a base 12, and a power transmission sliding ring 19 is arranged in the base 12. The frame 10 can rotate 360 degrees, a control signal of an electric push rod 18 and a power supply are transmitted by relying on a signal sliding ring 20, and power generated by the generator is transmitted to the outside by relying on the power transmission sliding ring 19.

1. A downwind variable pitch wind turbine generator mainly comprising a wheel hub, a main shall, a generator, a frame and a base, characterized in that a synchronizing disc is arranged in the wheel hub, the synchronizing disc is connected with a fan blade connection slewing bearing through two joint bearings which are in mutual butt joint, a reciprocating rod connected with a sliding pair is arranged in the main shaft, one end of the reciprocating rod is connected with the synchronizing disc, the other end of the reciprocating rod is connected with a displacement sleeve, an electric push rod is arranged in the frame, the displacement sleeve is connected with the electric push rod, and the electric push rod is electrically connected with a signal sliding ring mounted in the base.

2. The downwind variable pitch wind turbine generator according to claim 1, characterized in that the wheel hub is connected with the main shall, through a connecting flange, the main shaft is connected with a main bearing seat and an auxiliary bearing, seat through a self-aligning roller bearing and fixed on the frame through an elastic support block, and the main shaft is connected with the generator through an elastic shaft coupling.

3. The downwind variable pitch wind turbine generator according to claim 1, characterized in that a slewing bearing is arranged between the frame and the base, and a power transmission sliding ring is arranged in the base.

4. The downwind variable pitch wind turbine generator according to claim 2, characterized in that a slowing bearing is arranged between the frame and the base, and a power transmission sliding ring is arranged in the base.
